(19) United States
(12) Patent Application Publication
(10) Pub. No.: US 2026/0100938 A1
(43) Pub. Date: Apr. 9, 2026

(54) METHOD AND SYSTEM FOR PROTECTING THE PRIVACY OF A MESSAGE IN MESSAGING APPLICATION

(71) Applicant: Dibyajyoti Dalai, McKinney, TX (US)

(72) Inventor: Dibyajyoti Dalai, McKinney, TX (US)

(21) Appl. No.: 19/333,547

(22) Filed: Sep. 19, 2025

Related U.S. Application Data
(60) Provisional application No. 63/702,683, filed on Oct. 3, 2024.

(51) Int. Cl. H04L 9/40

(52) U.S. Cl. CPC H04L 63/0428; H04L 63/0838; H04L 63/0861; H04L 63/105

(57) ABSTRACT

A method and system for enabling secured communication is provided herein. A communication and recipient information of the communication is received by a processor. The recipient information is selection of at least one recipient from a group of recipients. Selection of at least one privacy preference from a set of privacy preferences associated with the communication is received. An encrypted communication is generated by encrypting the communication using at least one encryption algorithm based on the at least one privacy preference. A decrypted communication is rendered on at least one corresponding output device associated with the each of the group of recipients by selectively decrypting the encrypted communication using at least one decryption algorithm based on the at least one privacy preference and the recipient information.

### TECHNICAL FIELD

This disclosure relates generally to messaging applications, and more particularly to method and system for protecting privacy of a message in a messaging application.

### BACKGROUND

Messaging applications have become a primary mode of communication which allows users to send texts, images, and media instantly across vast distances. These applications offer several features which aim at enhancing user experience, such as group chats, multimedia support, and privacy level. Despite these advancements, ensuring the privacy and security of user messages remains a significant challenge, especially when it comes to preventing unauthorized sharing and misuse of sensitive content.

One of the key issues faced by users on modern messaging applications is the inability to fully control the unauthorized distribution of their messages once they are sent. After a message is delivered, the recipient can easily copy, forward, or screenshot the message which potentially leads to unauthorized sharing or privacy breaches. In some cases, sensitive information is misused, shared without permission, or taken out of context, which may result in reputational damage, data leaks, or even financial loss.

Some existing messaging applications have addressed these concerns by implementing basic privacy features. For instance, certain applications allow users to set disappearing messages, which automatically deletes the messages after a specified period. Others enable encryption, which ensures that messages cannot be intercepted during transmission. These measures from the existing messaging applications are helpful but may be inadequate sometimes to fully prevent unauthorized use of message content, as the existing messaging applications may not provide protection that allows senders to enforce strict permissions on copying, forwarding, and screenshots. Therefore, there is a need for an efficient methodology to protect privacy of a message in a messaging application.

### SUMMARY OF THE INVENTION

In an embodiment, a method for enabling secured communication is disclosed. The method may include receiving, by a processor, a communication via a user device and recipient information of the communication. It may be noted that the recipient information is received based on a selection of at least one recipient from a group of recipients via the user device. The method may further include receiving, by the processor and via the user device, a selection of at least one privacy preference from a set of privacy preferences associated with the communication. The method may further include generating, by the processor, an encrypted communication by encrypting the communication using at least one encryption algorithm based on the at least one privacy preference. The method may further include rendering, by the processor, a decrypted communication on at least one corresponding output device associated with the each of the group of recipients by selectively decrypting the encrypted communication using at least one decryption algorithm based on the at least one privacy preference and the recipient information.

In an embodiment, a system for enabling secured communication is disclosed. The system may include a processor and a memory communicatively coupled to the processor. In an embodiment, the memory may store processor-executable instructions, which when executed by the processor, may cause the processor to receive, via a user device, a communication and recipient information of the communication. It may be noted that the recipient information may be received based on a selection of at least one recipient from a group of recipients via the user device. The processor may further receive, via the user device, at least one privacy preference from a set of privacy preferences associated with the communication. The processor may further generate an encrypted communication by encrypting the communication using at least one encryption algorithm based on the at least one privacy preference. The processor may further render a decrypted communication on at least one corresponding output device associated with the each of the group of recipients by selectively decrypting the encrypted communication using at least one decryption algorithm based on the at least one privacy preference and the recipient information.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary communication system for enabling secured communication, in accordance with an embodiment of the present disclosure.

FIG. 2 illustrates a functional system architecture that provides the underlying processing framework for implementing secured communication, in accordance with an embodiment of the present disclosure.

FIG. 3 illustrates a Graphic User Interface (GUI) of the messaging application enabled on the sender device, in accordance with an embodiment of the present disclosure.

FIG. 4 illustrates a Graphic User Interface (GUI) of the messaging application enabled on the sender device, in accordance with an embodiment of the present disclosure.

FIG. 5 illustrates a GUI of the messaging application enabled on the recipient device, in accordance with an embodiment of the present disclosure.

FIG. 6 illustrates an exemplary GUI depicting exemplary decrypted communication on an interface of the messaging application, in accordance with an embodiment of the present disclosure.

FIG. 7 illustrates a flow diagram of a method for enabling secured communication, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

Modern messaging applications face significant challenges in protecting user privacy and preventing unauthorized distribution of sensitive communications. Recipients can easily copy, forward, screenshot, or capture communication content through external devices, leading to potential privacy breaches, data leaks, and unauthorized sharing of confidential information. Existing privacy features such as disappearing messages and basic encryption provide limited protection and fail to address the fundamental issue of controlling message interactions after delivery to recipient devices. Additionally, conventional messaging systems may lack comprehensive group-based messaging architectures that can effectively manage multi-user communications with varying privacy requirements and authentication protocols.

The present disclosure addresses these challenges through a communication system 100 that enables secured communication with comprehensive privacy protection features. The communication system 100 implements selective encryption and decryption mechanisms based on configurable privacy preferences, allowing senders to control how recipients interact with messages through various authentication methods and access controls. The communication system 100 may utilize a group-based messaging architecture with producer-consumer models that facilitate scalable message distribution while maintaining security protocols. The communication system 100 may utilize a group-based messaging architecture with producer-consumer models that facilitate scalable message distribution while maintaining security protocols. The system may incorporate Message Queuing Telemetry Transport (MQTT) protocol implementation for efficient message routing and delivery, Web Real-Time Communication (WebRTC) for peer-to-peer communication capabilities, HTTPS for secure data transmission, and JSON Web Token (JWT) based authentication and validation processes that ensure secure access control.

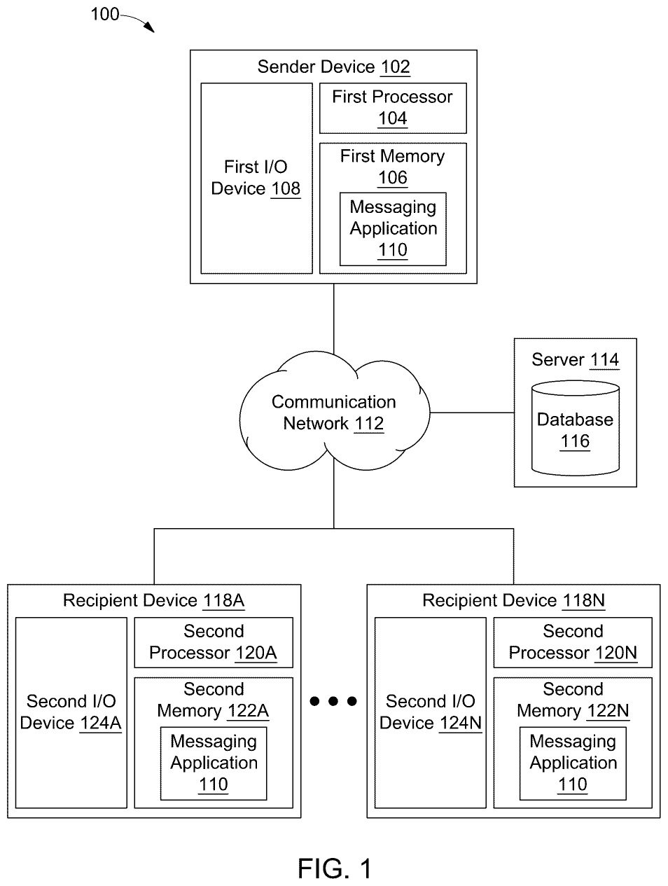

FIG. 1 illustrates a block diagram of an exemplary communication system 100 for enabling secured communication 110 is illustrated, in accordance with an embodiment of the present disclosure. In an embodiment, enabling secured communication is essential to prevent unauthorized usage or distribution of a communication content in form of, but not limited to, text, image, video or audio. In order to achieve this, a recipient may be restricted from propagating the communication content by various methodologies such as, but not limited to, copying, pasting, forwarding, downloading, or capturing the content via screenshots or recordings and so on. Accordingly, the communication system 100 may include various components that enable secure communication between a sender device 102 and one or more recipient devices 118A-118N as discussed in detail below. The communication system 100 includes a communication network 112 that may communicably couple the sender device 102 and the one or more recipient devices 118A-118N (individually and collectively referred to hereinafter as 118). It may be noted each of the sender device 102 may be a device from which a communication originates and the one or more recipient devices 118A-118N may be devices for which the communication is meant to be directed to. It may be noted that roles of the sender and the receiver may be interchangeable as any of the one or more of recipient devices 118A-118N may become the sender device 102 depending on origination of the communication. In an embodiment, the sender device 102 and the recipient devices 118 may be a computing system, including but not limited to, a smart phone, a laptop computer, a desktop computer, a workstation, a portable computer, a handheld, or a mobile device. Further, the communication system 100 may include a server 114 that may include a database 116. The sender device 102 includes a first processor 104, a first memory 106, and a first input/output device 108 that work together to enable secured communication functionality. Similarly, each of the one or more recipient devices 118 may include a second processor 120A-120N (individually and collectively referred to hereinafter as 120), a second memory 122A-122N (individually and collectively referred to hereinafter as 122), and a second input/output (I/O) device 124A-124N (individually and collectively referred to hereinafter as 124).

In an embodiment, the first processor 104 and the second processor 120 may include, but are not limited to, microcontrollers, microprocessors, digital signal processors (DSPs), application-specific integrated circuits (ASICs), field-programmable gate arrays (FPGAs), system-on-chip (SoC) components, or any other suitable programmable logic devices. Examples of the first processor 104 and the second processor 120 may include but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors.

The first memory 106 and the second memory 122 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM). Further, the first memory 106 and the second memory 122 may store a messaging application 110 that provides the interface and processing capabilities for implementing secured communication. The first processor 104 and the second processor 120 may execute processor-executable instructions stored in the first memory 106 or the second memory 122 respectively to implement various functionalities such as receive communications via the sender device 102 and recipient information based on selection of one or more recipients from a group of recipients via the sender device 102, encrypting messages, selecting privacy levels, and managing access permissions, as will be discussed in greater details herein below.

The server 114 may operate as a central communication hub that may manage message the operation of the messaging application 110, routing, encryption key distribution, and access control enforcement between the sender device 102 and the one or more recipient devices 118A-118N. In an embodiment, the server 114 may function as a Protected Message Validation Gateway that validates message recipients and manages authentication workflows. The server 114 may implement MQTT protocol for efficient message queuing and delivery, enabling scalable group-based messaging with producer-consumer architecture. The server 114 includes a database 116 that stores encrypted communications, recipient information, privacy preferences, JWT tokens with appropriate permissions, and authentication data required for selective decryption processes. The server 114 may generate and manage JWT tokens that contain user permissions and access controls, facilitating secure message validation and recipient authentication through HTTPS secure communication channels. The server 114 performs additional encryption when forwarding messages to recipient devices and continuously monitors attempts to interact with messages, recording both authorized and unauthorized actions taken by recipients. Additionally, the server 114 generates notifications to the sender device 102 when unauthorized access attempts occur, including details such as the time of the attempt, the device used by the recipient, and the specific action that was blocked. The server 114 may also support WebRTC implementation for direct peer-to-peer communication between devices when enhanced real-time messaging capabilities are required. In an embodiment, the server 114 may include one or more processors (not shown) that may enable the various functionalities to provide secured communication is accordance with the embodiments of the present disclosure.

The communication network 112 facilitates data transmission between the sender device 102, server 114, and the one or more recipient devices 118A-118N using various network implementations and communication protocols. The communication network 112 can be implemented as ethernet IP network, intranet, local area network (LAN), wide area network (WAN), the internet, Wi-Fi, LTE network, CDMA network, or 5G networks. The communication network 112 uses a variety of protocols including Hypertext Transfer Protocol Secure (HTTPS), Transmission Control Protocol/Internet Protocol (TCP/IP), and Wireless Application Protocol (WAP) to enable reliable and secure data transmission. The communication network 112 may also support WebRTC protocols for establishing direct peer-to-peer connections between devices, enabling real-time communication capabilities with reduced latency. The communication network 112 supports both wired and wireless connections, allowing the sender device 102 and recipient devices to communicate through multiple network pathways while maintaining encryption and security protocols throughout the transmission process.

In an embodiment, the first I/O device 108 and the second I/O devices 124 may include variety of interface(s), for example, interfaces for data input and output devices, and the like. The first I/O device 108 may facilitate inputting of instructions by the sender communicating with the sender device 102. Similarly, the second I/O device 124A-124N of the one or more recipient device 118A-118N may include variety of interface(s), for example, interfaces for data input and output devices, and the like. The second I/O device 108B may facilitate inputting of instructions by the recipient communicating with the one or more recipient devices 118A-118N. In an embodiment, the first I/O device 108 may be wirelessly connected to the sender device 102 through wireless network interfaces such as Bluetooth®, infrared, or any other wireless radio communication known in the art. In an embodiment, the first I/O device 108 may be connected to a communication pathway for one or more components of the sender device 102 to enable the transmission of inputted instructions and output results of data generated by various components such as, but not limited to, first processor(s) 104 and first memory 106. In an embodiment, the second I/O device 124A-124N may be wirelessly connected to the one or more recipient device 118A-118N through wireless network interfaces such as Bluetooth®, infrared, or any other wireless radio communication known in the art. In an embodiment, the second I/O device 124 may be connected to a communication pathway for one or more components of the recipient device 102 to enable the transmission of inputted instructions and output results of data generated by various components such as, but not limited to, the second processor(s)120A-120N and second memory 122A-122N.

In an illustrative configuration, the second processor 120 of the recipient device 118 may enable reception and processing of encrypted communications. The second processor 120 may executes instructions to render decrypted communications on the second input/output device 124 associated with recipients by selectively decrypting encrypted communications using one or more decryption algorithms based on privacy preferences and recipient information. Similarly, additional recipient devices up to 118N include corresponding processors 120N, memories 122N, and input/output devices 124N that provide the same decryption and rendering capabilities. The second memory 122A and second memory 122N store the messaging application 110 and processor-executable instructions that, when executed by the respective processors, cause the processors to authenticate recipients using authentication inputs and generate decrypted communications based on selective decryption and authentication results.

The messaging application 110 stored in the first memory 106 and second memories 122 of recipient devices 118 may be communicably coupled with the server 114 and may provide the user interface for implementing secured communication methods. The messaging application 110 may implement a group-based messaging architecture that supports producer-consumer models, where users can create groups with unique identifiers and manage message distribution through MQTT protocol implementation. The messaging application 110 may receive selections of privacy preferences from sets of privacy preferences associated with communications, enabling senders to configure protection levels and access controls that may be saved in the server 114. The server 114 may generate encrypted communications by encrypting communications using one or more encryption algorithms based on selected privacy preferences, ensuring that message content remains protected during transmission and storage. The messaging application 110 may incorporate JWT token-based authentication where tokens are created with appropriate permissions for different user groups and access levels, with secure token exchange facilitated through HTTPS communication channels. The messaging application 110 may also implement WebRTC capabilities for real-time peer-to-peer communication, enabling direct multimedia transmission between devices with enhanced security protocols. Moreover, the messaging application 110 may implement authentication mechanisms including pattern matching-based access that requires recipients to draw or enter predefined graphical patterns or Personal Identification Numbers (PINs) to unlock messages, voice recognition-based access that utilizes recipient voice for authentication, and geofencing with precise latitude and longitude coordinates for location-based access control, and send the result of the authentication to the server 114. The messaging application 110 may also support fake message generation using local AI engines that can create alternative message content for enhanced privacy protection. Thus, the server 114 may generate a decrypted communication and transmit to the messaging application 110 on at least one corresponding output device associated with the each of the group of recipients 118 by selectively decrypting the encrypted communication using at least one decryption algorithm based on the at least one privacy preference and the recipient information.

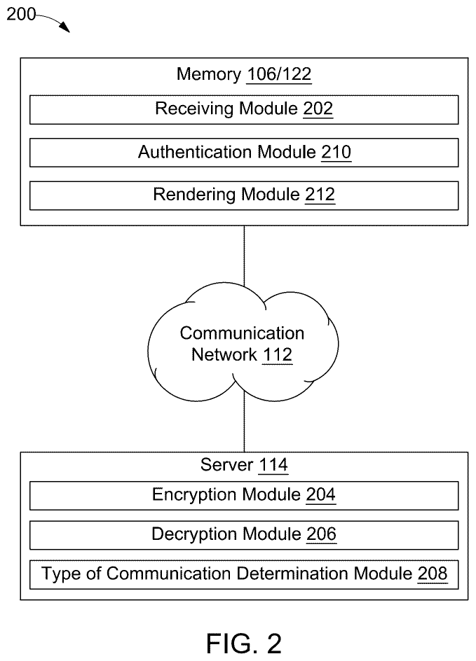

FIG. 2 illustrates a functional system architecture 200 that provides the underlying processing framework for implementing secured communication, in accordance with an embodiment of the present disclosure. FIG. 2 is explained in conjunction with FIG. 1. The functional system architecture 200 may be implemented as a standalone application, a plugin, an extension or an Application Programming Interface (API) within the messaging application 110 provided by the server 114 on each of the sender device 102 and recipient devices 118A-118N. The functional system architecture 200 may incorporate MQTT protocol implementation for message queuing and routing, enabling efficient group-based communication with producer-consumer architecture. The functional system architecture 200 may also integrate WebRTC protocols for peer-to-peer communication capabilities and HTTPS for secure API communications and data transmission between system components. The functional system architecture 200 may be implemented within the server 114, the first memory 106 of the sender device 102 and the second memory 122 of the recipient devices 118A-118N to enable comprehensive message processing and protection capabilities. The functional system architecture 200 may include multiple interconnected processing modules such as the first memory 106 and the second memory 122 including a receiving module 202, an authentication module 210 and a rendering module 212 and the server 114 including an encryption module 204, a decryption module 206, and a type of communication determination module 208. The server 114 may function as a Protected Message Validation Gateway that manages JWT token validation, user authentication workflows, and message permission controls. The rendering module 212 may render corresponding Graphic User Interfaces (GUIs) of the messaging application 110 on both the sender device 102 and the recipient devices 118 to receive user inputs and display one or more options to the user.

The receiving module 202 may receive communications via the sender device 102 and recipient information of the communications. The receiving module 202 may facilitate the selection of one or more recipients from a group of recipients via the sender device 102, supporting group-based messaging architecture with unique group identifiers. The receiving module 202 may process group creation requests and manage producer-consumer relationships within the messaging system using MQTT protocol for efficient message distribution. Further, the receiving module 202 may facilitate the selection of at least one privacy preference from a set of privacy preferences associated with the communication via the sender device 102. In an embodiment, the communication may include a plurality of type of communication. Further the plurality of types of communication may include a text message, an audio message and a multimedia message. The receiving module 202 may also handle multimedia content including image, video, and audio files through cloud-based file upload and sharing mechanisms with HTTPS secure transmission protocols. The receiving module 202 may also coordinate with WebRTC implementations for real-time multimedia communication processing and peer-to-peer data exchange. The user (hereinafter referred to as “the sender”) may access the messaging application 110 stored in the first memory 106 of the sender device 102 by interacting with the first I/O device 108 (e.g., touchscreen, keyboard, microphone). Upon launching the messaging application 110, the user may be presented with an interface to compose the message.

After composing the message, the sender may designate a privacy level for the message using the messaging application 110. For instance, the messaging application 110 provides options to the sender for designating a privacy level of protection for the message. In an embodiment the set of privacy preference may include a set of privacy levels. Further, the set of privacy levels may include, but not limited to, a low level, a medium level, and a high level. The messaging application 110 may also provide enhanced camera protection options including watermarking and blurring techniques that may be applied to prevent unauthorized capture of message content. The watermarking feature may embed identifiable information such as sender username, timestamp, or recipient username directly into the visual content, while the blurring feature may obscure message content when unauthorized viewing conditions are detected. The user may designate at least one of the privacy level from the set of privacy levels based on the desired level of privacy to transmit the communication to the one or more recipient device 118A-118N.

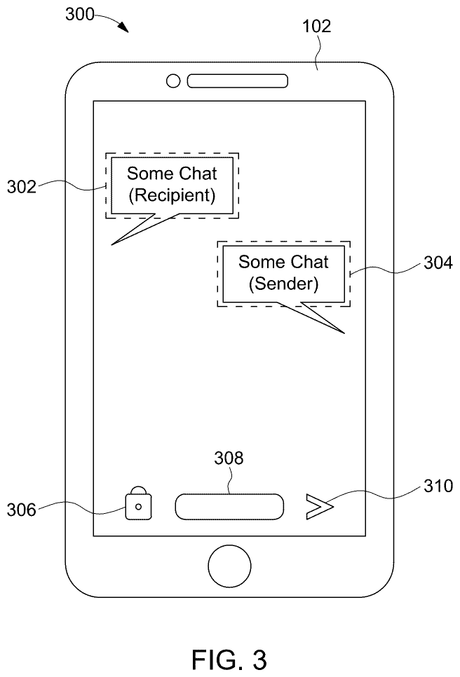

Referring now to FIG. 3, a Graphic User Interface (GUI) 300 of the messaging application 110 enabled on the sender device 102 of FIG. 1 is illustrated, in accordance with an exemplary embodiment of the present disclosure. The GUI 300 may include a recipient message area 302 and a sender message area 304, wherein the areas may facilitate display of communications received from recipients and sent by senders respectively. A privacy control button 306 may be provided within the messaging interface 300 to enable selection of privacy preferences for outgoing communications. The privacy control button 306 may enable the sender to apply a level of privacy to the outgoing message. The privacy control button 306 may offer various selectable privacy levels (e.g., Low, Medium and High), which may be applied before the message is sent. Upon pressing the privacy control button 306, the sender may be presented with a selection window or a drop-down menu showing the available privacy levels, such as Low, Medium and High. The sender may choose one of these options depending on the sensitivity of the message content.

The GUI 300 may further include a message input field 308 where users may compose communications, and a send button 310 for transmitting the composed communications. In an embodiment, the message formation box 308 may also support multimedia input, such as attaching files, images, or voice recordings, depending on the functionality of the messaging application 110. The receiving module 202 may process input from the message input field 308 and may coordinate with other modules to apply selected privacy preferences to the communications.

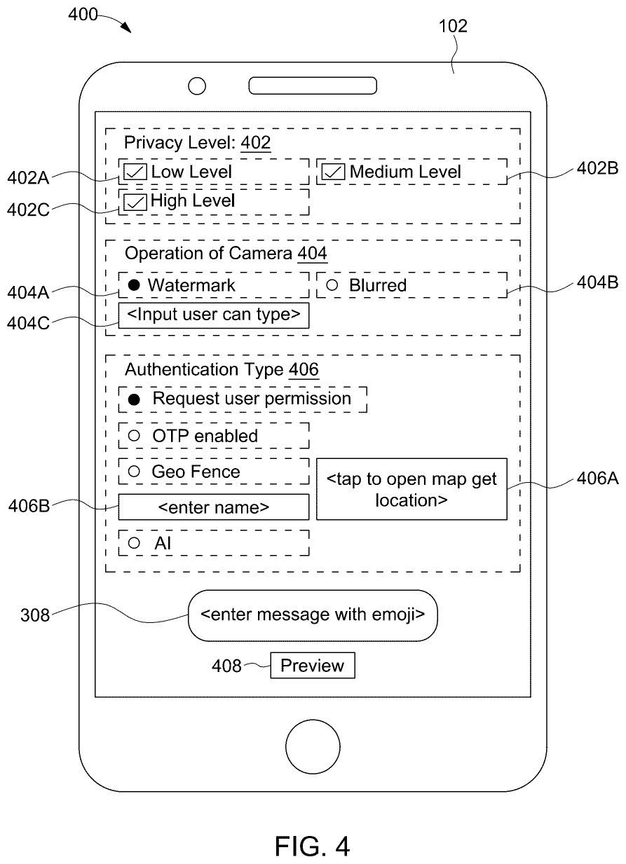

Referring now to FIG. 4, a Graphic User Interface (GUI) 400 of the messaging application 110 enabled on the sender device 102 of FIG. 1 is illustrated, in accordance with an exemplary embodiment of the present disclosure. The GUI 400 is displayed on the sender device 102 when the sender clicks on the privacy control button 306 from the previous screen in GUI 300. The graphical user interface 400 may include a privacy level box 402 that may include various selectable options of the set of privacy levels such as low level 402A, medium level 402B and high level 402C. It may be noted further additional privacy options such as operation of camera 404 is provided such as “Watermark”404A and “Blurred”404B.

The “Watermark” 404A option when selected, a watermark may be applied over the message content displayed on the recipient device 118, making it more difficult for a recipient to misuse the message by capturing it with an external device such as a camera. The watermark may include identifiable information such as sender username, timestamp, or recipient username, making the message content traceable. The “Blurred” 404B option may blur the message content and it may appear blurred if the message is viewed in unauthorized conditions. An input box 404C may allow the sender to provide specific instructions or keywords that may be related to the watermark or blurred message features. For instance, the sender may type “Confidential” or “Do Not Share,” which may be incorporated into the watermark or blurred content. At the bottom of the GUI 400, the message input field 308 allows the sender to view and edit the composed message. The sender may input or edit the message content here, while the selected privacy protections from the above sections will be applied upon sending. Lastly, the preview button 408 is provided which may allow the sender to view how the message will appear to the recipient before finalizing and sending it. In an embodiment, the preview button 408 helps the sender confirm that all intended privacy protections are applied correctly and offers an opportunity to adjust if necessary.

With continued reference to FIG. 2, the encryption module 204 of the server 114 may generate encrypted communications by encrypting the communications using one or more encryption algorithms based on the selected privacy preferences. The encrypted communication may be an unreadable format that may be a ciphertext to hide the communication in order to prevent from the unauthorized use. The encryption module 204 may utilize standard or custom encryption protocols such as JSON Web Tokens (JWTs), Advanced Encryption Standard (AES) or Rivest-Shamir-Adleman (RSA) to secure communication content. The encryption module 204 may implement JWT token-based encryption where messages are wrapped with cryptographic protection and JWT tokens are created with appropriate user permissions and access controls. The encryption process may incorporate MQTT protocol for secure message queuing and routing within the group-based messaging architecture. The encryption module 204 may also integrate with HTTPS protocols to ensure secure transmission of encrypted data and authentication tokens between system components. For real-time communications, the encryption module 204 may coordinate with WebRTC security protocols to maintain end-to-end encryption during peer-to-peer multimedia transmission. The encryption process may be controlled as per the selected privacy preference as illustrated in FIG. 3 and privacy levels 402, operation of camera 404 as illustrated in FIG. 4.

With continued reference to FIG. 2, the decryption module 206 of the server 114 may perform selective decryption of encrypted communications based on privacy preferences and recipient information. The decryption module 206 may implement JWT token validation processes to verify user permissions and access rights before proceeding with message decryption. The decryption module 206 may include a type of communication determination module 208 that may determine a type of communication from a plurality of types of communication. In one example, the plurality of types of communication may include, but not limited to, a text message, an audio message and a multimedia message including image, video, and audio files transmitted through cloud-based storage mechanisms. The decryption module 206 may be communicably coupled with an authentication module 210 of the recipient device 116 that may authenticate one or more recipients using one or more authentication inputs corresponding to the privacy preferences from a set of authentication inputs. The set of authentication inputs may include a one-time password (OTP), biometric data, a permission response, location data with precise latitude and longitude coordinates, time-based restriction, a graphical pattern, a voice input, and an artificial intelligence (AI) verification. The authentication module 210 may enforce multi-factor authentication (MFA) workflows that may combine multiple authentication methods such as OTP verification with geofencing or biometric data with permission-based access controls before granting recipients access to the encrypted communication. The authentication inputs may be received based on the type of communication and the privacy preferences. The decryption module 206 may utilize HTTPS secure channels for authentication data transmission and may coordinate with WebRTC protocols for real-time decryption of multimedia content during peer-to-peer communication sessions. The decryption module 206 may generate a decrypted communication based on the selective decryption and a result of the authentication performed by the authentication module 210.

In an embodiment, the OTP-based authentication inputs require the recipient to enter an OTP sent to their registered email or phone number to access the communication. In an embodiment, the biometric data-based authentication inputs require the recipient to provide at least one of biological identifiers, such as fingerprint, iris scan, facial recognition, etc. in order to access the communication. In an embodiment, the permission response-based authentication inputs require the recipient to request for authorization from the sender and the sender to provide confirmation of the authorization.

In an embodiment, the location data-based authentication inputs limits access to the communication based on a geographic location of the one or more recipient device 118A-118N, which may be enforced using GPS data of the one or more recipient device 118A-118N with precise latitude and longitude coordinates specified by the sender. The geofencing system may create virtual boundaries around specific geographic areas, and messages may only be accessible when the recipient device is positioned within these predefined coordinates. Accordingly, the message will only be accessible within a specified geographical area, defined by the sender using interactive map interfaces that allow precise coordinate selection. The aforementioned feature may be particularly useful for restricting the viewing of sensitive information to specific locations, such as office premises or designated event areas. The geofencing implementation may continuously monitor the recipient device location and automatically encrypt or decrypt message content based on real-time position data. Accordingly, the tap to open button 406A of GUI 400 may allow the sender to interactively select a location on a map interface by defining the boundaries for the geo-fence. The sender may also enter a name for the geo-fenced area in the input box 406B, which may help in identifying and managing multiple geo-fenced areas.

Similarly time-based restriction may create restriction around specific timelines, and messages may only be accessible to the recipient device within the specified timeline. For example, a time-based restriction for 9 am-5 pm will allow the recipients to view the communication between 9 am-5 pm. The time line for the time-based restriction may be defined by the sender using a GUI of the messaging application 110.

In an embodiment, the graphical pattern-based authentication inputs require the recipient to draw or enter a predefined graphical pattern. In an embodiment, the voice input-based authentication inputs utilize voice of the recipient for authentication, allowing access only after successful voice verification.

In an embodiment, the artificial intelligence (AI) verification utilizes the AI algorithms to analyse the communication prior to grant access to the communication. For example, the AI may detect and classify the content based on the training data to identify the content as harmful, violent or otherwise restricted content. The AI verification system may also implement fake message generation capabilities using local AI engines that can create alternative message content for enhanced privacy protection. The local AI engines may generate fake messages with message identifiers that can be used to obscure the original content while maintaining communication flow. In one example, AI algorithms may be used to dynamically assess the conditions for decrypt the encrypted message. For example, AI may analyze the behavior of the recipient or context of the message to determine if it is safe to display the message. The AI system may also monitor user interactions and detect unauthorized attempts to access protected content, automatically generating notifications to the sender when suspicious activities are detected. Upon such detection, the AI may prompt the recipient for confirmation to proceed. The content may be displayed to the recipient only after the recipient explicitly confirms access.

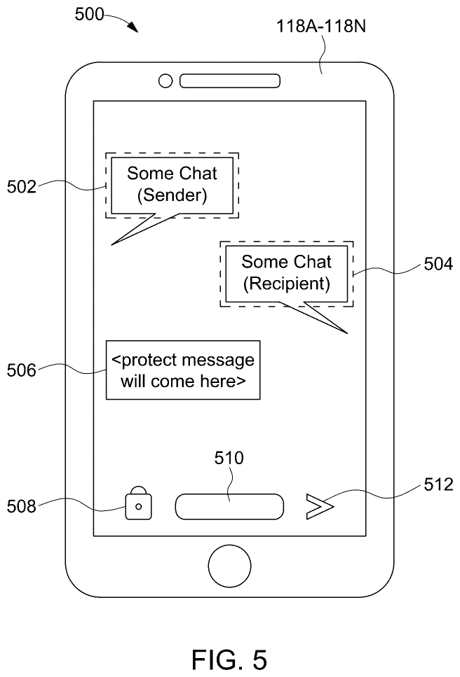

Referring now to FIG. 5, a GUI 500 of the messaging application 110 enabled on the recipient device 118 of FIG. 1 is illustrated, in accordance with an exemplary embodiment of the present disclosure. The GUI 500 provides an interface through which the recipient interacts with messages, including the messages that have been sent by the sender with various levels of privacy protection applied. The GUI 500 may implement group-based messaging interfaces that support producer-consumer communication models with MQTT protocol integration for efficient message routing. The GUI 500 is designed to allow uniform communication while ensuring that any privacy or protection levels defined by the sender are implemented on the recipient device 118 through JWT token validation and multi-factor authentication workflows. The decryption module 206 may coordinate with the messaging interface 500 illustrated in FIG. 5 to manage recipient access to protected communications through the Protected Message Validation Gateway. The messaging interface 500 may include a sender message area 502, a recipient message area 504, and a protected message area 506 for displaying decrypted communications based on various privacy preferences and authentication results. The rendering module 212 may coordinate with the recipient devices 118 to display decrypted communication based on the privacy preference and the recipient information. It may be noted that decrypted communication may be an obscured communication for all non-selected recipients from the group of recipients. Further, the decrypted communication may be initially an obscured communication for the selected recipients from the group of recipients and may be further selective decrypted as propagable communication based on the result of the authentication of the corresponding recipient. A security control panel 508 may provide controls for managing authentication processes, while a message input field 510 may allow composition of responses. An interface control panel 512 may provide additional controls for managing the messaging interface 500 and may facilitate communication between the recipient devices 118A-118N.

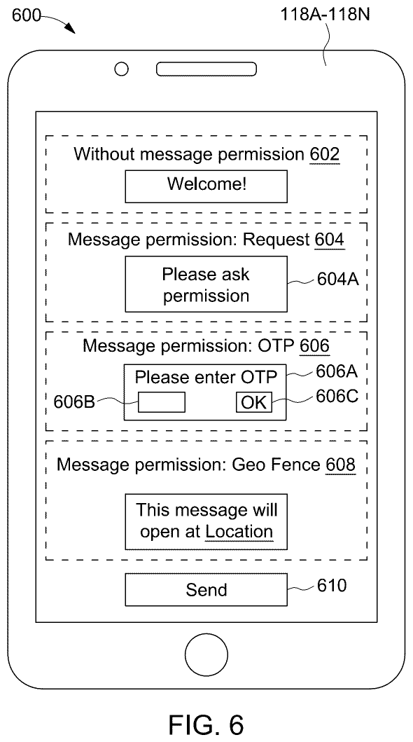

Referring now to FIG. 6 exemplary GUI 600 depicting exemplary decrypted communication on an interface of the messaging application 110 is illustrated, in accordance with exemplary embodiments of the present disclosure. The rendering module 212 of the recipient devices 118 may coordinate with the server 114 functioning as a Protected Message Validation Gateway to display a GUI 600 to display decrypted communication based on the privacy preference and the recipient information. The GUI 600 may implement JWT token-based authentication workflows and support various permission request mechanisms through MQTT protocol communication. It may be noted that decrypted communication may be an obscured communication for all non-selected recipients from the group of recipients. Further, the decrypted communication may be initially an obscured communication for the selected recipients from the group of recipients. In an example, the GUI 600 may be displayed, once an input to select or view the decrypted communication displayed in the protected message area 506 of GUI 500 is received. The GUI 600 may include a welcome interface 602 which may display content for which no specific permissions are required. Further, the GUI 600 may include a permission request interface 604 that may allow recipients to request permission of the sender to view protected or encrypted or obfuscated communications through the Protected Message Validation Gateway. Upon selection of the permission asking option 604A, the sender may receive a notification along with recipient information requesting permission to access the protected communication through the server's monitoring and notification system. The sender may either accept or reject such a request leading to respectively allowing or not allowing the recipient to view the propagable communication. Further, the GUI 600 may include an OTP verification interface 606 that may further include an OTP prompt 606A, an OTP input field 606B where recipients may enter verification codes, and a confirmation button 606C for submitting entered OTPs. Further, the GUI 600 may include a geofence interface 608 may indicate when communications may be accessible at specific locations defined by precise latitude and longitude coordinates, and a send button 610 may enable transmission of responses or verification inputs.

With continued reference to FIG. 2, the authentication module 210 may process authentication inputs received through the GUI 600 via the various interface elements and may generate authentication results and send to the server 114 that may determine whether recipients may access the encrypted communications. In one embodiment, the authentication module 210 may implement JWT token validation processes and coordinate with the Protected Message Validation Gateway to verify user permissions and access rights. The authentication module 210 may support multi-factor authentication workflows that combine various authentication methods such as OTP verification, biometric data validation, geofencing with precise coordinates, and AI-based verification processes. The authentication module 210 may utilize HTTPS secure communication channels for transmitting authentication credentials and validation results to ensure data integrity during the authentication process. For real-time authentication scenarios, the authentication module 210 may integrate with WebRTC protocols to enable secure peer-to-peer authentication exchanges, particularly for voice recognition and biometric verification processes. The type of communication determination module 208 of the server 114 may analyze communication content to classify communications and may coordinate with the authentication module 210 that may apply appropriate authentication requirements based on the determined communication type. The module may also handle multimedia content classification for image, video, and audio files transmitted through cloud-based storage mechanisms. In an example, for a communication including a voice message, a voice-based authentication may be requested, while multimedia messages may require enhanced authentication protocols including watermarking or blurring protection mechanisms.

Further, the decryption module 206 may generate a decrypted communication based on the selective decryption and a result of the authentication. The decryption module 206 may implement JWT token validation and coordinate with the Protected Message Validation Gateway to ensure proper access control enforcement. In an embodiment, the decryption module 206 may be a propagable communication or an obscured communication generated based on selectively decrypting the encrypted communication using the at least one decryption algorithm based on the result of the authentication. The decryption process may incorporate fake message generation capabilities using local AI engines that can create alternative content when unauthorized access is detected. In an example, in case based on the result of authentication determined by the authentication module 210, a recipient from the group of recipients is unauthenticated, the decryption module 206 may generate an obscured communication for the unauthenticated recipient or may trigger fake message generation to protect the original content. However, in case based on the result of authentication determined by the authentication module 210, a recipient from the group of recipients is authenticated, the decryption module 206 may generate a propagable communication for the authenticated recipient with appropriate watermarking or blurring protection based on the selected privacy preferences.

Thus, the rendering module 212 may render obscured communications to each of the group of recipients that are unauthenticated based on the result of the authentication. The rendering module 212 may coordinate with the Protected Message Validation Gateway and implement JWT token-based access control to determine appropriate content display. In an example, the obscured communications may be displayed through the welcome interface 602 or may prompt recipients to complete authentication processes through the permission request interface 604 or OTP verification interface 606. The rendering module 212 may also trigger fake message generation using local AI engines when unauthorized access attempts are detected, providing alternative content that maintains communication flow while protecting the original message. The rendering module 212 may render propagable communications to one or more recipients upon being authenticated based on the result of the authentication, with appropriate watermarking or blurring protection applied based on the selected privacy preferences and camera protection settings.

In accordance with the exemplary embodiment of FIG. 6, the rendering module 212 may coordinate with various interface elements to provide comprehensive access control and communication rendering capabilities through the Protected Message Validation Gateway. The geofence interface 608 may work in conjunction with geographic location determination that may be based on Global Positioning System (GPS) with precise latitude and longitude coordinates, network-based location services, or any other suitable method for determining physical location of recipient devices. The geofencing system may create virtual boundaries and continuously monitor device location to enable or disable message access based on real-time position data. When the privacy level may be determined as the low privacy level, the propagable communication may be propagable by the recipient using each of the set of propagation techniques, allowing greater flexibility in communication sharing. The access permission requirements may include permission based access, One-Time-Password (OTP) based access, pattern matching-based access, geo tagging-based access with coordinate validation, voice recognition-based access, and Artificial Intelligence (AI) based access with fake message generation capabilities. The OTP-based access may require recipients to enter an OTP sent to their registered email or phone number to access communications, wherein the OTP verification interface 606 may facilitate this process through the OTP input field 606B and confirmation button 606C with JWT token validation for secure authentication workflows.

In continued reference to FIG. 2, the generation of propagable communications by the decryption module 206 may vary based on the selected privacy level from a set of privacy levels that may include, but not limited to, a low level, a medium level and a high level. When the privacy level may be determined as the high level, the propagable communication generated may be a view only communication that may prevent copying, forwarding, or screenshot capabilities. When the privacy level may be determined as the medium level, the propagable communication generated may be watermarked and may be propagable by the recipient using one of a set of propagation techniques such as forwarding the watermarked communication. The watermark may include identifiable information such as sender username, timestamp, or recipient username, making the message content traceable, and may be semi-transparent to avoid obstructing the message content while still providing a visible deterrent. When the privacy level may be determined as the low level, the propagable communication generated may be propagable by the recipient using each of the set of propagation techniques. It may be noted that configuration of generation of propagable communication by enabling one or more propagation techniques may be predefined by the sender for each of the type of messages and for each of the various privacy levels. Thus, privacy preferences may be

The set of propagation techniques may vary differently based on the type of communication. For example, when the type of communication is the text message then the set of propagation techniques may include viewing, copying, forwarding, and taking a screenshot on the one or more recipient device 118A-118N. Similarly, when the type of communication is audio message then the propagation techniques may include listening, downloading, forwarding, and recording on the one or more recipient device 118A-118N. And when the type of communication is the multimedia message including image, video, and audio files transmitted through cloud-based storage mechanisms, then the set of propagation techniques may include viewing, downloading, forwarding, taking a screenshot, and recording on the one or more recipient device 118A-118N. The multimedia content may be protected using watermarking techniques that embed identifiable information or blurring techniques that obscure content under unauthorized viewing conditions. Accordingly, the decryption module 206 may generate a decrypted communication based on the type of communication and the privacy preferences enabling or disabling one or more set of propagation techniques. The system may also implement fake message generation using local AI engines to provide alternative content when unauthorized propagation attempts are detected. Accordingly, the sender may also configure various privacy preferences by defining required protection as per user preference through the group-based messaging architecture with producer-consumer models.

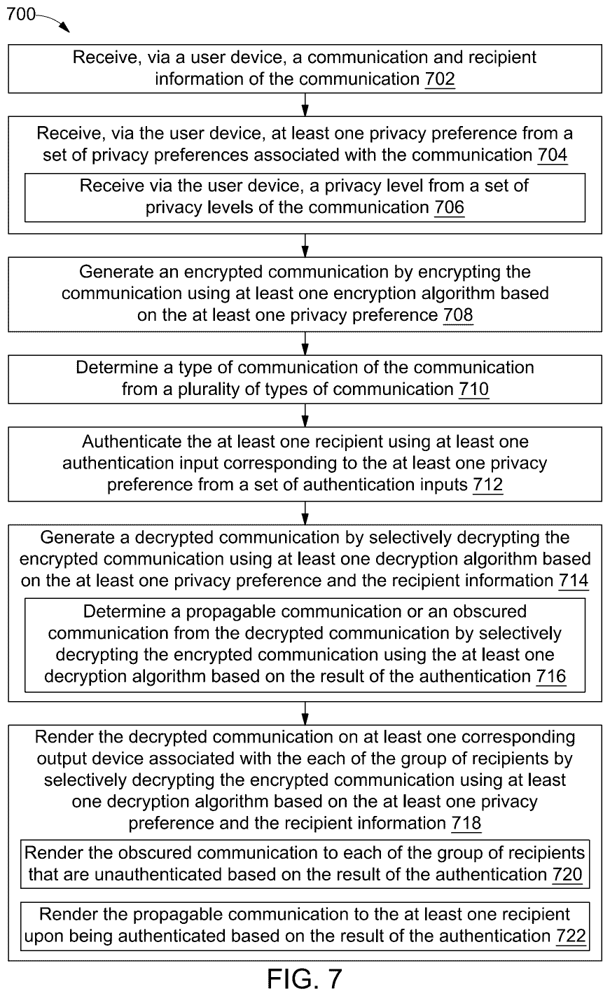

FIG. 7 illustrates a flow diagram 700 of a method for enabling secured communication, in accordance with an embodiment of present disclosure. The flow diagram 700 may provide a comprehensive framework for controlling message accessibility through privacy preferences. FIG. 7 is explained in conjunction with the FIGS. 1-2. In an embodiment, the flow diagram 700 may include a plurality of steps that may be performed by various modules of the sender device 102 or the one or more recipient device 118 so as to enable secured communication.

The flow diagram 700 may commence at a step 702 where the receiving module 202 may receive a communication via the sender device 102 and recipient information of the communication. The recipient information may be received based on a selection of one or more recipients from a group of recipients via the sender device 102. The step 702 may involve the receiving module 202 processing incoming communication requests and identifying intended recipients for the message. The communication may include text messages, multimedia content, or other forms of digital communication that require privacy preference based access control. Additionally, the step 702 may capture metadata associated with the communication, including sender identification, timestamp information, and initial privacy preferences specified by the sender. The information captured by the receiving module 202 may be transmitted to the server 114.

At a step 704, the server 114 may receive a selection of one or more privacy preferences from a set of privacy preferences associated with the communication via the sender device 102. The step 704 may involve the sender device 102 presenting a set of privacy levels through the messaging interface 300. Each of the privacy level may allow protection such as geographic restrictions, authentication requirements, and display parameters for their messages. The privacy preferences may include location-based access controls, time-based restrictions, and recipient-specific permissions that govern how, when and where the message can be accessed. Moreover, the step 704 may enable senders to define multiple privacy layers, creating complex access scenarios that combine geographic boundaries with other authentication factors.

A step 706 may involve the communication system 100 receiving a privacy level from a set of privacy levels of the communication via the user device. The step 706 may allow users to select from low, medium, or high privacy levels, with each level corresponding to different geographic restriction parameters and authentication requirements. The privacy level selection may determine the granularity of location-based controls, with higher privacy levels requiring more precise geographic positioning and additional verification steps. The step 706 may also establish the foundation for subsequent authentication procedures by defining the security parameters that will govern message accessibility based on selected privacy level.

In an illustrative configuration, a step 708 may involve the encryption module 204 generate an encrypted communication by encrypting the communication using one or more encryption algorithms based on the one or more privacy preferences. The step 708 may apply privacy-specific encryption keys that correspond to the selected privacy preferences, including authentication-based encryption that requires specific verification methods before decryption and geographic-based encryption that restricts message access to predefined geographic regions. The encryption process may incorporate privacy parameters such as biometric data requirements, time-based restrictions, location-based access controls, or permission-based access controls as part of the encryption algorithm, creating a direct link between message accessibility and the chosen privacy settings including geographic boundaries. Furthermore, the step 708 may generate multiple encryption layers, with each layer corresponding to different privacy levels or authentication requirements specified by the sender, such as OTP verification, voice recognition, geographic location verification, or AI-based content analysis.

The flow diagram 700 may continue to a step 710 where the type of communication determination module 208 may determine a type of communication from a plurality of types of communication. The step 710 may analyze the content and format of the encrypted communication to establish appropriate access protocols for different message types based on various privacy preferences. Text messages may require basic verification procedures, while multimedia messages may demand more stringent authentication procedures. The step 710 may also consider the sensitivity level of the communication type when establishing privacy restrictions, with certain message types automatically triggering enhanced security measures based on the selected privacy preferences including geography-based, time-based, biometric-based, or permission-based controls.

At step 712, the authentication module 210 may authenticate one or more recipients using one or more authentication inputs corresponding to the one or more privacy preferences from a set of authentication inputs. The step 712 may incorporate different types of authentication based on the privacy preferences such as authentication factors, including geography-based preferences that verify the recipient device is within specified geographic boundaries, time-based preferences that restrict access to certain hours or dates, biometric preferences requiring fingerprint or facial recognition, and permission-based preferences requiring explicit sender approval. The authentication process may combine multiple privacy preference types simultaneously, such as location verification with biometric data or one-time passwords with voice recognition, depending on the privacy preferences established in earlier steps. Additionally, the step 712 may continuously monitor compliance with the selected privacy preferences throughout the authentication process.

At step 714 the decryption module 206 may generate a decrypted communication by selectively decrypting the encrypted communication using one or more decryption algorithms based on the one or more privacy preferences and the recipient information. The step 714 may apply privacy preference-specific decryption keys that become active based on different criteria: geography-based keys that activate when the recipient device is positioned within designated areas, time-based keys that unlock during specified time windows, biometric keys that require successful biological verification, or permission-based keys that activate upon sender authorization. The decryption process may verify compliance with multiple privacy preference types simultaneously before proceeding with content decryption. Moreover, the step 714 may implement dynamic decryption protocols that adjust the level of content accessibility based on real-time compliance with various privacy preferences including geographic proximity, temporal restrictions, biometric verification status, or permission grant status.

In an illustrative configuration, at step 716 the decryption module 206 may generate a propagable communication or an obscured communication from the decrypted communication by selectively decrypting the encrypted communication using the one or more decryption algorithms based on the result of the authentication. The step 716 may evaluate the recipient's compliance with various privacy preference types and authentication status to determine whether the message should be displayed in full or in an obscured format. Recipients who fail to meet geography-based requirements by being outside designated boundaries, time-based requirements by accessing outside permitted hours, biometric requirements by failing biological verification, or permission-based requirements by lacking sender approval may receive obscured communications that provide limited information about the message content. The step 716 may also consider the combination of privacy preference types when determining the appropriate rendering format, with multiple privacy preference violations requiring stricter compliance before displaying propagable communications.

At step 718 the rendering module 212 may render the decrypted communication on one or more corresponding output devices associated with each of the group of recipients by selectively decrypting the encrypted communication using one or more decryption algorithms based on the one or more privacy preferences and the recipient information. The step 718 may display the message content only when the recipient device meets all specified privacy preference requirements, including geography-based compliance by being within approved areas, time-based compliance by accessing during permitted periods, biometric compliance through successful biological verification, and permission-based compliance through sender authorization. The rendering process may continuously monitor compliance with all active privacy preferences during message display, automatically obscuring or hiding the content if any privacy preference requirement is violated. Furthermore, the step 718 may apply privacy preference-specific display parameters, such as geography-based watermarks, time-limited visibility, biometric-triggered content masking, or permission-dependent interaction controls, based on the recipient's current compliance status with various privacy preference types.

At step 720, the obscured communication module 214 may render the obscured communication to each of the group of recipients that are unauthenticated based on the result of the authentication. The step 720 may display limited message information or placeholder content to recipients who fail to meet various privacy preference requirements, including those positioned outside designated geographic boundaries, accessing outside permitted time windows, failing biometric verification, or lacking sender permission. The obscured communication may include basic message metadata, such as sender information and timestamp, while concealing the actual message content until proper compliance with all specified privacy preferences is achieved. Additionally, the step 720 may provide recipients with guidance on how to access the full message content, including information about required geographic locations, permitted access times, necessary biometric verification steps, or procedures for requesting sender permission, depending on the specific privacy preference types that have been violated.

A step 722 may involve the propagable communication module 216 rendering the propagable communication to the one or more recipients upon being authenticated based on the result of the authentication. The step 722 may display the complete message content to recipients who successfully satisfy all privacy preference requirements, including geography-based authentication by being positioned within designated boundaries, time-based authentication by accessing during permitted periods, biometric authentication through successful biological verification, and permission-based authentication through sender approval. The propagable communication may include full access to text content, multimedia elements, and interactive features, with the level of access determined by the specific combination of privacy preferences and compliance status. Moreover, the step 722 may enable additional message interaction capabilities, such as reply functions, content sharing, copying, forwarding, or screenshot abilities, based on the recipient's continued compliance with all active privacy preference types including geographic restrictions, temporal limitations, biometric requirements, and permission-based controls established by the sender.

As will be appreciated by those skilled in the art, the techniques described in the various embodiments discussed above are not routine, or conventional, or well-understood in the art. The techniques discussed above provide for enabling secured communication.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem. In addition to enable secured communication, the disclosed method and system may encrypt the communication based on the designated privacy level by the user.

The specification has described a method and system for enabling secured communication. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, CD ROMs, DVDs, flash drives, disks, and any other known physical storage media.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

It is intended that the disclosure and examples be considered as exemplary only, with a true scope and spirit of disclosed embodiments being indicated by the following claims.

What is claimed is:

1. A method for enabling secured communication, the method comprising:
receiving, by a processor, a communication via a user device and recipient information of the communication,
wherein the recipient information is received based on a selection of at least one recipient from a group of recipients via the user device;
receiving, by the processor and via the user device, a selection of at least one privacy preference from a set of privacy preferences associated with the communication;
generating, by the processor, an encrypted communication by encrypting the communication using at least one encryption algorithm based on the at least one privacy preference; and
rendering, by the processor, a decrypted communication on at least one corresponding output device associated with the each of the group of recipients by selectively decrypting the encrypted communication using at least one decryption algorithm based on the at least one privacy preference and the recipient information.

2. The method of claim 1, wherein the selection of the at least one privacy preference from the set of privacy preferences comprises:
selecting, by the processor and via the user device, a privacy level from a set of privacy levels of the communication, wherein the set of privacy levels comprises a low level, a medium level and a high level.

3. The method of claim 2, wherein the selective decryption comprises at least one of:
determining, by the processor, a type of communication from a plurality of types of communication; and
authenticating, by the processor, the at least one recipient using at least one authentication input corresponding to the at least one privacy preference from a set of authentication inputs; and
generating, by the processor, a decrypted communication based on the selective decryption and a result of the authentication.

4. The method of claim 3, wherein the at least one authentication input from the set of authentication inputs is received based on the type of communication and the at least one privacy preference,
wherein the set of authentication inputs comprises: a one-time password (OTP), a biometric data, a permission response, a location data, a graphical pattern, a voice input, and an artificial intelligence (AI) verification, and
wherein the plurality of types of communication comprises a text message, an audio message and a multimedia message.

5. The method of claim 4, comprises:
determining, by the processor, a propagable communication or an obscured communication from the decrypted communication by selectively decrypting the encrypted communication using the at least one decryption algorithm based on the result of the authentication.

6. The method of claim 5, comprises:
rendering, by the processor, the obscured communication to each of the group of recipients that are unauthenticated based on the result of the authentication; and
rendering, by the processor, the propagable communication to the at least one recipient upon being authenticated based on the result of the authentication.

7. The method of claim 6, wherein the propagable communication is a view only communication in case the privacy level is determined as the high level.

8. The method of claim 7, wherein the propagable communication is watermarked and is propagable by the at least one recipient using one of a set of propagation techniques in case the privacy level is determined as the medium level.

9. The method of claim 7, wherein the propagable communication is propagable by the at least one recipient using each of the set of propagation techniques in case the privacy level is determined as the low privacy level.

10. A system for enabling secured communication, the system comprising:
a processor; and
a memory communicatively coupled to the processor, wherein the memory stores processor-executable instructions, which when executed by the processor, cause the processor to:
receive, via a user device, a communication and recipient information of the communication,
wherein the recipient information is received based on a selection of at least one recipient from a group of recipients via the user device;
receive, via the user device, at least one privacy preference from a set of privacy preferences associated with the communication,
generate an encrypted communication by encrypting the communication using at least one encryption algorithm based on the at least one privacy preference; and
render a decrypted communication on at least one corresponding output device associated with the each of the group of recipients by selectively decrypting the encrypted communication using at least one decryption algorithm based on the at least one privacy preference and the recipient information.

11. The system of claim 10, wherein the selection of the at least one privacy preference from the set of privacy preferences comprises:
selecting, via the user device, a privacy level from a set of privacy levels of the communication, wherein the set of privacy levels comprises a low level, a medium level and a high level.

12. The system of claim 2, wherein the selective decryption comprises at least one of:
determine, a type of communication from a plurality of types of communication; and
authenticate, the at least one recipient using at least one authentication input corresponding to the at least one privacy preference from a set of authentication inputs; and
generate, a decrypted communication based on the selective decryption and a result of the authentication.

13. The system of claim 3, wherein the at least one authentication input from the set of authentication inputs is received based on the type of communication and the at least one privacy preference,
wherein the set of authentication inputs comprises: a one-time password (OTP), a biometric data, a permission response, a location data, a graphical pattern, a voice input, and an artificial intelligence (AI) verification, and
wherein the plurality of types of communication comprises a text message, an audio message and a multimedia message.

14. The system of claim 4, wherein the processor-executable instructions, when executed by the processor, cause the processor to:
determine, a propagable communication or an obscured communication from the decrypted communication by selectively decrypting the encrypted communication using the at least one decryption algorithm based on the result of the authentication.

15. The system of claim 5, wherein the processor-executable instructions, when executed by the processor, cause the processor to:
render, the obscured communication to each of the group of recipients that are unauthenticated based on the result of the authentication; and
render, the propagable communication to the at least one recipient upon being authenticated based on the result of the authentication.

16. The system of claim 6, wherein the propagable communication is a view only communication in case the privacy level is determined as the high level.

17. The system of claim 7, wherein the propagable communication is watermarked and is propagable by the at least one recipient using one of a set of propagation techniques in case the privacy level is determined as the medium level.

18. The system of claim 7, wherein the propagable communication is propagable by the at least one recipient using each of the set of propagation techniques in case the privacy level is determined as the low privacy level.

19. A computer program product for enabling secured communication, the computer program product comprising a non-transitory computer-readable storage medium having computer-readable program code embodied therewith, the computer-readable program code configured to, when executed by a processor, cause the processor to:
receive a communication via a user device and recipient information of the communication,
wherein the recipient information is received based on a selection of at least one recipient from a group of recipients via the user device;
receive, via the user device, a selection of at least one privacy preference from a set of privacy preferences associated with the communication;
generate an encrypted communication by encrypting the communication using at least one encryption algorithm based on the at least one privacy preference; and
render a decrypted communication on at least one corresponding output device associated with the each of the group of recipients by selectively decrypting the encrypted communication using at least one decryption algorithm based on the at least one privacy preference and the recipient information.

20. The computer program product of claim 19, wherein the selection of the at least one privacy preference from the set of privacy preferences comprises:
selecting, via the user device, a privacy level from a set of privacy levels of the communication, wherein the set of privacy levels comprises a low level, a medium level and a high level.

21. The computer program product of claim 20, wherein the selective decryption comprises at least one of:
determining a type of communication from a plurality of types of communication; and authenticating the at least one recipient using at least one authentication input corresponding to the at least one privacy preference from a set of authentication inputs; and
generating a decrypted communication based on the selective decryption and a result of the authentication.

22. The computer program product of claim 21, wherein:
the at least one authentication input from the set of authentication inputs is received based on the type of communication and the at least one privacy preference,
the set of authentication inputs comprises: a one-time password (OTP), a biometric data, a permission response, a location data, a graphical pattern, a voice input, and an artificial intelligence (AI) verification, and
the plurality of types of communication comprises a text message, an audio message and a multimedia message.

23. The computer program product of claim 22, wherein the computer-readable program code is further configured to cause the processor to:
determine a propagable communication or an obscured communication from the decrypted communication by selectively decrypting the encrypted communication using the at least one decryption algorithm based on the result of the authentication.

24. The computer program product of claim 23, wherein the computer-readable program code is further configured to cause the processor to:
render the obscured communication to each of the group of recipients that are unauthenticated based on the result of the authentication; and
render the propagable communication to the at least one recipient upon being authenticated based on the result of the authentication.

25. The computer program product of claim 24, wherein the propagable communication is a view only communication in case the privacy level is determined as the high level.

26. The computer program product of claim 25, wherein the propagable communication is watermarked and is propagable by the at least one recipient using one of a set of propagation techniques in case the privacy level is determined as the medium level.

27. The computer program product of claim 25, wherein the propagable communication is propagable by the at least one recipient using each of the set of propagation techniques in case the privacy level is determined as the low privacy level.
